(19) United States
(12) Patent Application Publication
(10) Pub. No.: US 2006/0198277 A1
(43) Pub. Date: Sep. 7, 2006

(54) Apparatus for reading/writing an optical storage carrier

(75) Inventor: Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/559,356

(22) PCT Filed: Jun. 3, 2004
(86) PCT No.: PCT/IB04/01880

§ 371 Date: Dec. 6, 2005

(30) Foreign Application Priority Data
Jun. 11, 2003 (EP) 03300029.0

(51) Int. Cl. G11B 7/135

(52) U.S. Cl. 369/112.03

(57) ABSTRACT

This apparatus comprises an optical head having the following elements: a light source for illuminating the optical carrier, a light detector for analyzing the light reflected from the optical carrier, an objective lens for focusing the light onto the optical carrier, and a grating device placed at the vicinity of said objective lens. The main optical elements are fixed together so that this disposal improves, the ability of the tracking of the head. DVD reader and recorder.

### FIELD OF THE INVENTION

The present invention relates to an apparatus for reading/writing an optical storage carrier—a grating device placed at the vicinity of said objective.

### BACKGROUND OF THE INVENTION

Such an apparatus is disclosed in the EP patent document no. 0 405 444.

This kind of known apparatus has problems especially in radial tracking in optical drives, in particular R/RW drives. A signal, which is called push-pull (PP) signal, is used for this radial tracking. It was noticed that the signal is sensitive to displacements of the spot on the detector that are caused by radial displacements of the objective lens due to the eccentricity of the disc (dynamic beam-landing) and to the misalignment of different optical components (static beam-landing).

### OBJECT AND SUMMARY OF THE INVENTION

The present invention proposes an apparatus as mentioned above in which measures for improving the performance of the tracking of the head are provided.

An apparatus for reading/writing an optical storage carrier having an optical head according to the invention comprises:

a light source for illuminating the optical carrier,

a light detector for analyzing the light reflected from the optical carrier,

an objective lens for focusing the light onto the optical carrier,

a grating device placed in at the vicinity of said objective lens.

When the grating and the objective lens and other optical materials are fixedly assembly together, the ability to track substantially improved.

These and other aspects of the invention are apparent from and will be elucidated, by way of non-limitative example, with reference to the embodiment(s) described hereinafter.

### BRIEF DESCRIPTION OF THE DRAWINGS

FIG. 1 shows an apparatus in accordance with the invention.

FIG. 2 shows the optical head in which the light path from light source to the optical carrier is shown.

FIG. 3 shows the structure of an optical head suitable for the apparatus of FIG. 1, in which the light path for the reflected light from the optical carrier is also shown.

FIG. 4 shows the structure of the grating element in accordance with the invention.

FIG. 5 shows the structure of the grating in accordance with the invention.

FIG. 6 shows the beam at THE astigmatic servo lens.

FIG. 7 shows the beam at detector level.

FIG. 8 shows the spot on the detector without grating element.

FIG. 9 shows the spot on the detector for given parameters with grating element.

FIG. 10 shows the improvement provided by the invention as regards the tracking error.

### DETAILED DESCRIPTION OF THE INVENTION

The FIG. 1 shows an apparatus in which a data carrier 1 is placed. This data carrier may be an optical disc. In FIG. 1, the carrier is shown in cross-section. A disc motor 3 rotates the carrier. On this carrier, a lens 12 incorporated in an optical head 13 focuses a laser light beam 14. This optical head 13 is mounted in an actuator 15 which is mounted in a sledge 16 which can be moved along the radius of the carrier under the control of electronic circuits, not shown in the figure, acting on a sledge motor 17. Inside this sledge, small movements are provided by actuator devices. There are actuator devices for the radial positioning referenced 20 and for focus positioning referenced 22. Arrow 26 indicates the directions of focus positioning and arrow 28 indicates the directions of radial positioning. The actuator is formed by electro-technical elements such as coils, magnet return springs, and so on. The sledge also contains photo-detectors, which provide signals. These signals are used on the one hand for displaying pictures on a screen 40, for example, and on the other hand for controlling various servos. A splitter device 42 directs these signals to the relevant devices. Among them, a signal TRf is used for focusing via a focusing device 45 and another TRr for radial positioning via the radial guidance device 50.

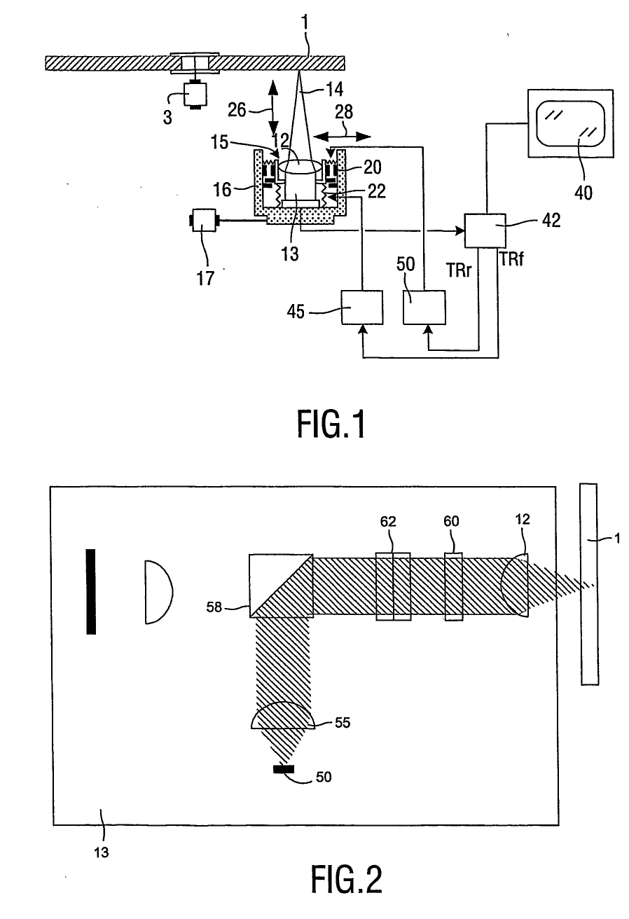

FIG. 2 shows the optical head 13 realized according to the invention. The head comprises a diode laser 50. A collimator lens 55 transmits the laser beam coming from the diode laser 50 through a polarizing beam splitter 58 having a cubic shape, to the laser disc 1 via various elements. The lens 12 focuses the beam on the disc 1, which beam had first passed through a quarter-wave plate (λ/4-plate) 60. According to an important aspect of the invention, a birefringent grating element 62 is provided in the vicinity of the lens 12.

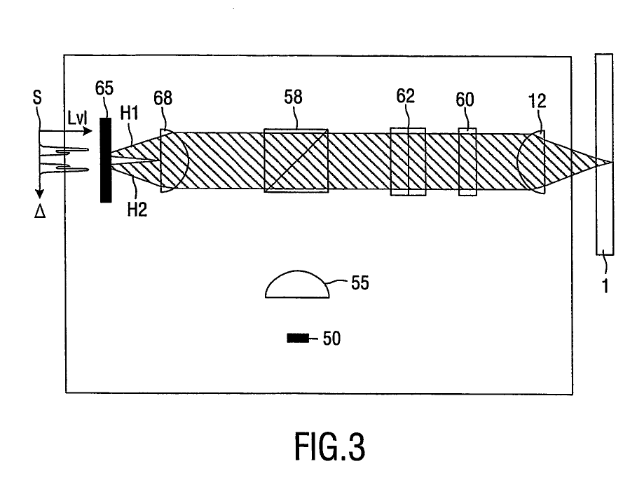

The FIG. 3 shows the same optical head 13. It is more detailed for the path of the beam light, which is reflected by the disc 1. This reflected light is directed to the polarizing beam splitter 58 and from this splitter towards a detector device 65 via a lens 68. This detector device is formed by segments placed on an area, which is preferably plane. As shown on FIG. 3, the reflected beam is split up into two equal halves H1 & H2, which appear at the output of the lens 68 thanks to the presence of the grating 62. According to the important aspect of the invention, the level of the signal considered in the detector device 65 has a form having the reference S in the Figure. The level Lv1 of the detected signal depends on the radial tracking error Δ.

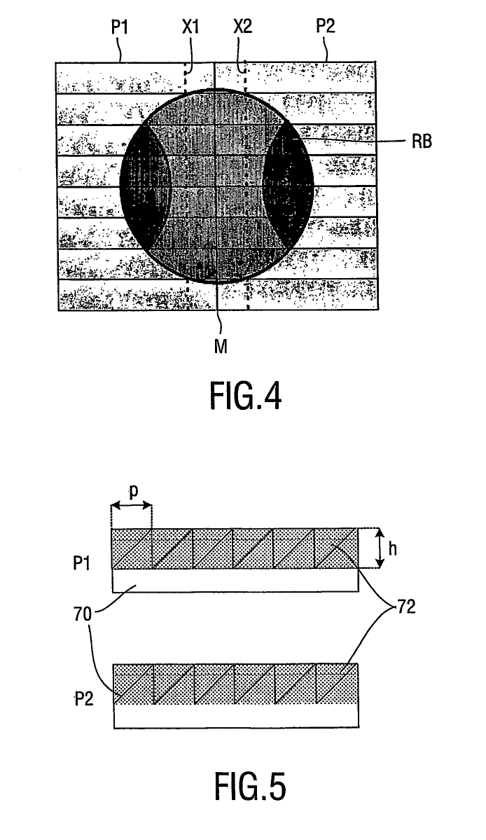

FIG. 4 shows the structure of the grating element 62. This grating element is formed by two parts P1 and P2, which are side-by-side along a line M. Their cross-sections are shown in FIG. 5. RB references the track of the return beam in FIG. 4. The cross sections mentioned are considered along dashed lines X1 and X2 in FIG. 5. The two parts P1 and P2 are placed in mutually reverse positions, asymmetrically, as shown in FIG. 5. The parts P1 and P2 are built on an isotropic substrate 70 on which is placed a birefringent layer 72. The grating has a pattern with a pitch p and a depth h.

The invention is based on the following considerations.

The beam-landing problem is usually solved with the three-spot push-pull (3SPP) method, at the expense of power efficiency and other errors.

The invention is based on a birefringent grating 62 which has no effect on passing light with one polarization and which splits the beam into equal halves for the orthogonal polarization. This can be used in a disc drive because of the way the polarization changes in a light path. On the way towards the disc the polarization is linear and is then made circular by the quarter-wave (λ/4) plate. Upon reflection at the disc, the handedness of the circular polarization changes. The polarization is made linear again when the light passes the (λ/4) plate on the return path, but the orientation of the linear polarization is orthogonal to the original orientation. If the birefringent grating is placed between the beam splitter and the (λ/4) plate, it will not affect the beam on the way to the disc but it does change the beam on the way from the disc to the detector.

The grating splits the return beam into two equal halves. A line parallel to the tracks on the disc divides the two halves. The left radial half gets an angular deviation in the tangential direction of α=λ/p, with p the pitch of the grating and λ the wavelength of the light, whereas the right radial half gets an angular deviation in the tangential direction of −α.

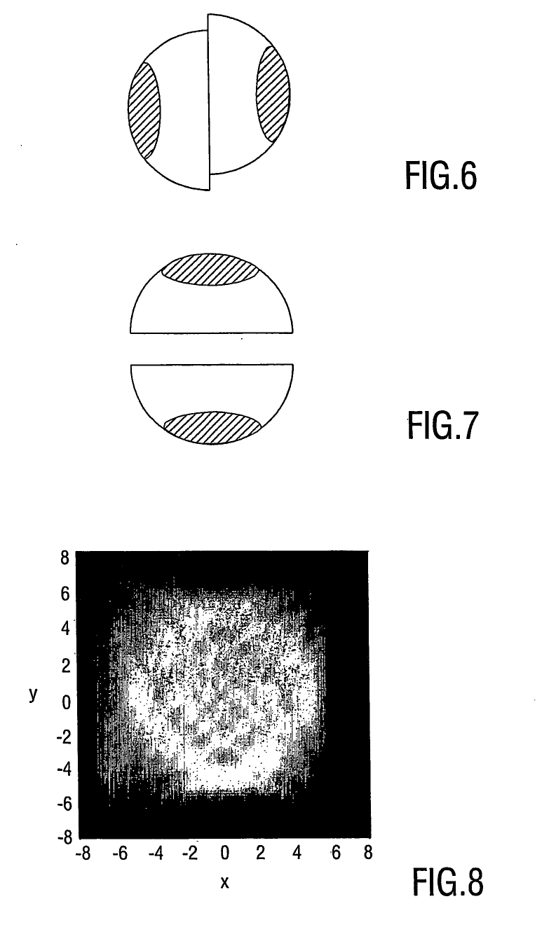

FIG. 6 shows the beam at the astigmatic servo lens and FIG. 7 at the detector plane. At the servo lens, the two halves are displaced in the tangential direction over a distance ˜Lα (with L the distance between the grating element and the servo lens), and have field angles ˜α. The field angles result in a displacement on the detector over a distance ˜b=˜fα in the tangential direction, with f the (average) focal length of the (astigmatic) servo lens. This distance may also be expressed as:

$$b = f α = \frac{a}{p} \frac{λ}{{NA}_{S}}$$

with “a” the pupil radius, and NAₛ, the numerical aperture at the detector side. The displacement of the beam ˜La at the servo lens will result in a displacement in the opposite direction equal to −Lα/a times the spot radius. The spot radius is approximately 2A₂₋₂/NA_{S}, giving the additional displacement as:

$$\frac{L α}{a} \frac{2 {A}_{2 - 2}}{{NA}_{S}} = \frac{2 {A}_{2 - 2}}{λ} \frac{λ L}{{a}^{2}} \frac{a}{p} \frac{λ}{{NA}_{S}}$$

With A₂₋₂=3.0× and the Fresnel-number a²/λL≈(1.75 mm²/(0.655 μm 20 mm) 236, it follows that the additional displacement is only a few percents of the displacement due to the field use of the servo lens. This contribution can therefore be safely disregarded. The width of the dark stripe on the detector will therefore be 2b. The two radial halves are rotated on the detector through 90 degrees due to the astigmatism at 45 degrees. This means that the radial information is along the tangential direction at the detector plane. The tangential separation of the two halves therefore implies that the detector can be displaced with respect to the beam through ˜b without affecting the push-pull signal. This solves the static beam-landing problem.

Dynamic beam landing related to displacement of the objective lens can also be solved if the grating and the λ/4-plate are attached to the actuator. Then these components will move together with the objective lens. Consequently, the beam in the return path will be split into two radial halves, which are still equal. Although the mass of the optical head is increased, which may decrease the mechanical bandwidth of the servo-system, the increased mass is not a disadvantage for low speed drives.

Grating Requirements:

A grating structure having the required effect has a blazed structure, the ‘sign’ of the blaze reversing from the left half to the right half (FIGS. 4 and 5). The layer on top of the blaze is a birefringent material, for example a liquid crystal polymer. The single axis of symmetry is either parallel of perpendicular to the linear polarization on the way from the disc to the detector. It is assumed to be parallel here. In that case the refractive index of the birefringent material on the way to the disc is equal to the ordinary refractive index n, and on the way from the disc to the detector to the extraordinary refractive index nₑ. The refractive index of the blazed substrate is n, and must be matched to the ordinary refractive index so that the grating has no effect on the beam to the disc:
n=nₒ
The extraordinary refractive index and the blaze height h must be tuned so that all light is diffracted into the 1st order. This means that:
h(nₑ−n)=λ
with “λ” the wavelength of the light. With typical nominal values of n=n₀=1.5 and nₑ=1.6, and a wavelength λ=0.655 pm, the blaze height is 6.55 μm.

A mismatch of the refractive indices of the birefringent material, due to e.g. variations in temperature or wavelength, must be avoided as much as possible. If the ordinary refractive index is not well matched some light will be diffracted into higher orders. The power efficiency is:

$${η}_{stray} = sin {c}^{2} [ π \frac{h ( {n}_{o} - n}{λ} ] \approx 1 - {\frac{1}{3} [ π \frac{h ( {n}_{o} - n )}{λ} ]}^{2}$$

with sin c(x)=sin(x)/x). With typical nominal values of n=n₀=1.5, and nₑ=1.6 the mismatch must be below 8×10⁻³ to keep the power losses below 2%. This is quite a strict demand.

If there is a mismatch in refractive indices on the way to the disc, there will be satellite spots on the disc, in addition to the problem of power loss. This is not a problem if they are sufficiently far away from the main 0th order spot so that they will not interfere with each other. The distance between diffraction orders on the disc is:

$${f}_{o} α = [ f α {NA}_{S} / NA ] \approx \frac{a}{p} \frac{λ}{NA}$$

and hence must be much larger than λ/NA. As a consequence, the pitch p must be much smaller than the pupil radius a, i.e. roughly 10 periods must fit in the pupil rim. On the way from the disc to the detector, a mismatch will result in some light being diffracted into the 0th order. The power fraction of this stray light is:

$${η}_{stray} = sin {c}^{2} [ π \frac{h ( {n}_{o} - n}{λ} ] \approx {[ π \frac{h ( {n}_{o} - n )}{λ} - 1 ]}^{2}$$

This fraction of the beam will suffer from beam landing, reducing the beam-landing margin for which an increase is wanted. If this fraction is required to be less than 5%, the mismatch in the extraordinary refractive index must be less than 2×10⁻².

The pitch of the grating determines the beam-landing margin on the detector. The spot diameter without grating follows from the wavelength λ=0.655 μm, the astigmatism A₂₋₂=3.0λ, and the servo numerical aperture NA_{S}=0.12 as 66 μm. Given the minimum ratio a/p=10, this spot will be split in two, the dark band being 2b=110 μm wide. With a pupil radius of 1.75 mm the detector focal length f follows as 15 mm, giving a field angle a=3.7×10⁻³=0.21 degree. This is still sufficiently small to avoid unwanted spot deformations due to the aberrations caused by the field use of the servo lens.

Spot Calculations:

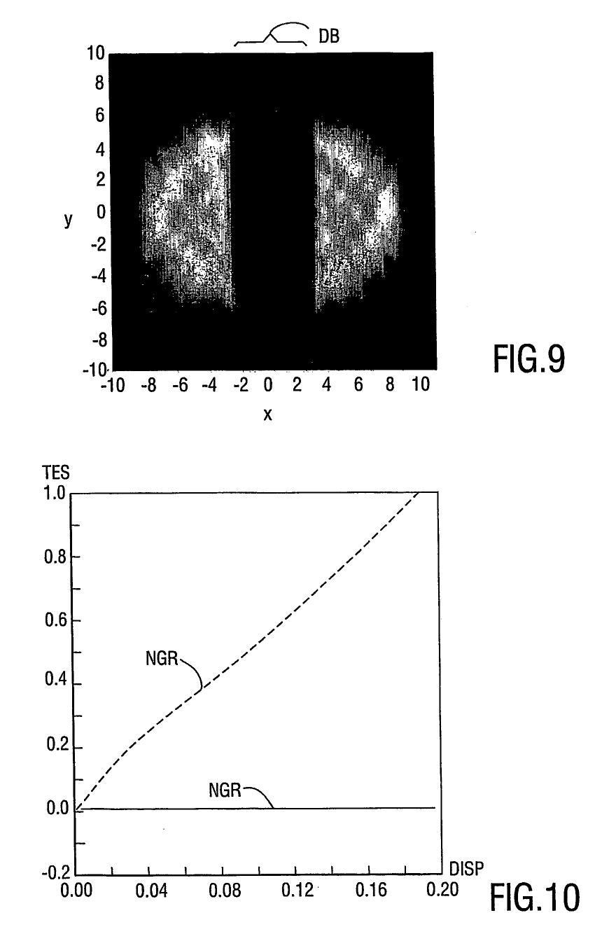

The effect of the birefringent grating on the spot on the detector can be modeled with diffraction theory. FIG. 8 shows the spot on the detector (in units λ/NA_{S}J for an astigmatism value of A₂₋₂=3× and DVD+RW parameters (, =0.655 pm, NA=0.65, track pitch 0.74 pm, phase difference between 0th and 1st orders π/2, radial position on track). The dark band DB in the middle of the spot due to the grating is shown in FIG. 9. The Tracking Error Signal (TES) according to the PP-method as a function of beam landing for both cases is shown in FIG. 10. Clearly, beam landing is no longer a problem in light paths with the birefringent grating.

The curve NGR is obtained without grating and the curve GR with a grating device. DSP is the beam displacement with respect to the pupil radius.

1- An apparatus for reading/writing an optical storage carrier having an optical head comprising:
a light source for illuminating the optical carrier,
a light detector for analyzing the light reflected from the optical carrier,
an objective lens for focusing the light onto the optical carrier,
a grating device placed at the vicinity of said objective lens.

2- An apparatus as claimed in claim 1, wherein the light detector is formed by segments placed in an area for analyzing the beam coming from the optical carrier, and wherein the grating is designed for splitting the beam into two substantially equal halves which end up at the detector plane separated by a dark band such that each of the two halves is captured by a different segment of said area.

3- An apparatus as claimed in claim 1, having an optical head that comprises inter alia a λ/4-plate.

4- An apparatus as claimed in claim 1, wherein the grating device has a blazed form, comprising a layer which is placed on top of the blaze and which is formed by a birefringent material, for example a liquid crystal polymer.

5- An apparatus as claimed in claim 2, having an optical head in which said grating vice and said λ/4-plate are attached to the actuator so that they move together with the objective.

6- An optical head suitable for an apparatus for reading/writing an optical storage carrier as claimed in claim 1.
